(19) United States
(12) Patent Application Publication
(10) Pub. No.: US 2024/0209658 A1
(43) Pub. Date: Jun. 27, 2024

(54) SWITCH CONFIGURATION FOR MOTOR VEHICLE LATCH

(71) Applicant: Brose Schließsysteme GmbH & Co. Kommanditgesellschaft, Wuppertal (DE)

(72) Inventors: David ROSALES, Rochester Hills, MI (US); Andrii LEVAKOV, Zubrí (CZ)

(73) Assignee: Brose Schließsysteme GmbH & Co. Kommanditgesellschaft, Wuppertal (DE)

(21) Appl. No.: 18/087,049

(22) Filed: Dec. 22, 2022

(51) Int. Cl. E05B 81/20; E05B 81/06; E05B 81/18; E05B 81/30; E05B 81/56; E05B 81/68; E05B 85/26; E05F 15/611

(52) U.S. Cl. CPC E05B 81/20; E05B 81/06; E05B 81/18; E05B 81/30; E05B 81/56; E05B 81/68; E05B 85/26; E05F 15/611; E05B 83/18; E05Y 2201/434; E05Y 2900/544; E05Y 2900/546

(57) ABSTRACT

A latch assembly configured to be fixed to a vehicle body of the vehicle or a closure of the vehicle. The latch assembly including a catch, a pawl, a controller and circuitry electrically connected to the controller. The circuitry including a first switch and a second switch. The first switch operable between a closed state, in which the first switch is configured to send first signals to the controller, and an open state. The second switch operable between a closed state, in which the second switch is configured to send second signals to the controller, and an open state. The controller configured to, responsive to receiving the first signals and not receiving the second signals, initiate a cinching sequence, in which the catch is configured to move from the secondary position to a primary position indicative of a second closed position.

### TECHNICAL FIELD

The present disclosure relates to a latch or locking mechanism for use in a motor vehicle.

### BACKGROUND

Vehicles include closures secured by latches that latch and lock the closures to the vehicle body when the closure is in a partially closed or fully closed position. Certain latches may be configured to provide a number of functions such as power closing, manual closing or locking, power release or opening, manual release, and cinching. Certain closures, such as tailgates used primarily in pickup trucks or vehicles with cargo beds require two latches to secure the tailgate to the truck bed when the tailgate is in the closed or partially closed position.

### SUMMARY

According to one embodiment, a latch assembly for use in a vehicle is provided. The latch assembly may be configured to be fixed to a vehicle body of the vehicle or a closure of the vehicle. The latch assembly may include a catch, a pawl, a controller and circuitry electrically connected to the controller. The circuitry may include a first switch and a second switch. The first switch may be operable between a closed state, in which the first switch is configured to send first signals to the controller, and an open state. The second switch may be operable between a closed state, in which the second switch is configured to send second signals to the controller, and an open state. The controller may be configured to, responsive to receiving the first signals and not receiving the second signals, collectively indicative of the pawl and the catch each moving from an open position towards a secondary position indicative of a first closed position, initiate a cinching sequence, in which the catch is configured to move from the secondary position to a primary position indicative of a second closed position.

According to another embodiment, a closure assembly for use in a motor vehicle is provided. The motor vehicle includes a body and a closure element configured to move with respect to the body between an open position, a first closed position, and a second closed position. The closure assembly includes a controller and a latch assembly provided with a catch, a pawl, a first switch, a second switch, and a controller. The catch and the pawl may be collectively configured to move between an open position, a secondary position, and a primary position. The catch and pawl may also be collectively configured to cooperate with one another in at least one of the secondary position and the primary position. The first switch may be operable between a closed state and an open state and configured to detect positions of at least one of the catch and the pawl. The second switch may be operable between a closed state and an open state and configured to detect positions of the other of the at least one of the catch and the pawl. The controller may be configured to, responsive to one of the first and second switches being in the closed state, collectively indicative of the pawl and the catch each moving from the open position towards the secondary position, initiate a cinching sequence, in which the catch is configured to move from the secondary position to a primary position indicative of the second closed position.

According to yet another embodiment, a method of operating a closure assembly including a latch and a closure is provided. The method may include receiving, by a controller, first signals from a first switch. The first switch operable between an open state and a closed state, in which the first switch sends the first signals to the controller. The method may also include not receiving, by the controller, second signals from a second switch operable between an open state and a closed state, in which the second switch sends the first signals to the controller, and performing, by the controller, a cinching operation. The receiving step and the not receiving step may be collectively indicative of a pawl and a catch of the latch each moving from an open position to a secondary position indicative of the closure being in a first closed position.

### BRIEF DESCRIPTION OF THE DRAWINGS

FIG. 1 illustrates a perspective view of an exemplary vehicle and closure.

FIG. 2 illustrates a perspective view of a closure latch assembly.

FIG. 3A illustrates a side view of a latch of the latch assembly in an open position.

FIG. 3B illustrates a side view of the latch in a partially closed position.

FIG. 3C illustrates a side view of the latch in a fully closed position.

FIG. 4 illustrates a schematic wiring diagram of an exemplary electrical circuit.

FIG. 5 illustrates a graphical representation of actuation of a closure assembly.

### DETAILED DESCRIPTION

Embodiments of the present disclosure are described herein. It is to be understood, however, that the disclosed embodiments are merely examples and other embodiments can take various and alternative forms. The figures are not necessarily to scale; some features could be exaggerated or minimized to show details of particular components. Therefore, specific structural and functional details disclosed herein are not to be interpreted as limiting, but merely as a representative basis for teaching one skilled in the art to variously employ the embodiments. As those of ordinary skill in the art will understand, various features illustrated and described with reference to any one of the figures can be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications or implementations.

This invention is not limited to the specific embodiments and methods described below, as specific components and/or conditions may, of course, vary. Furthermore, the terminology used herein is used only for the purpose of describing particular embodiments of the present invention and is not intended to be limiting in any way.

As used in the specification and the appended claims, the singular form “a,” “an,” and “the” also contemplates plural referents unless the context clearly indicates otherwise. For example, reference to a component means one or more components. The term “substantially” or “about” may be used herein to describe disclosed or claimed embodiments. The term “substantially” or “about” may modify a value or relative characteristic disclosed or claimed in the present disclosure. In such instances, “substantially” or “about” may signify that the value or relative characteristic it modifies is within +0%, 0.1%, 0.5%, 1%, 2%, 3%, 4%, 5% or 10% of the value or relative characteristic.

Directional terms used herein are made with reference to the views and orientations shown in the exemplary figures. One or more central axes are shown in the figures and described below. Terms such as “outer” and “inner” are relative to the central axis. For example, an “outer” surface means that the surfaces faces away from the central axis, or is outboard of another “inner” surface. Terms such as “radial,” “diameter,” “circumference,” etc. also are relative to the central axis. The terms “front,” “rear,” “upper” and “lower” designate directions in the drawings to which reference is made. The terms, connected, attached, etc., refer to directly or indirectly connected, attached, etc., unless otherwise indicated explicitly or by context.

Although the terms first, second, third, etc. may be used to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Vehicles may include a number of closures and a number of latches that are configured to latch and/or lock the closures to the vehicle body. Under certain circumstances, two latches may be required to fix one or more of the closures to the vehicle body. For example, two latches may be required to lock a tailgate, generally used in pickup trucks, to the vehicle body.

Known vehicle latches include at least two switches that are configured to detect operating states of the latch. Generally, these switches are interconnected by at least two separate electrical traces and each of the switches include a switching leg that switches between an open state, a first closed state, and a second closed state.

The present disclosure contemplates simplifying the circuitry of a vehicle latch. As an example, the simplified circuitry may include two switches that are only connected by a common electrical trace. This simplified electrical circuit may be less expensive and more efficient to operate.

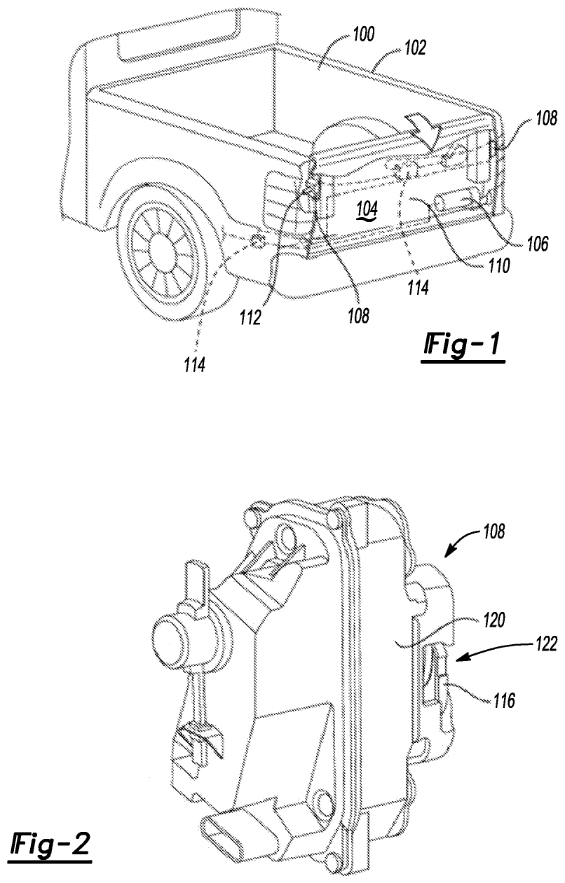

Referring generally to the figures, a vehicle 100 including a vehicle body 102 and a closure element 104 is provided. The vehicle 100 may be a pickup truck or another type of vehicle such as an SUV or sedan and the closure 104 may be a tailgate. A power drive unit 106 may be provided to move the closure 104 from a closed position (FIG. 1) as indicated by the directional arrow in FIG. 1. The closure 104 may be part of a closure assembly 110 that may include the power drive unit 106 and one or more latch assemblies 108 that may be configured to engage a striker 112 that may be fixed to either the vehicle body 102 or the closure 104. The power drive unit 106 and each of the latch assemblies 108 may be operatively connected to one or more controllers 114.

One or more (e.g., both) of the latch assemblies 108 may include a catch 116 that may be configured to move (e.g., rotate) to engage the striker 112 to lock or latch the closure 104 to the body 102 and a pawl 118 may be provided to engage the catch 116 to lock the catch 116 in one or more positions.

FIG. 1 illustrates a perspective view of a portion of the vehicle 100. The vehicle may be a pickup truck, but the present disclosure contemplates other types of vehicles. The vehicle 100 may include a vehicle body 102 and the closure assembly 110. The closure assembly may include the closure element 104 such as a tailgate and one or more actuators, such as the power drive unit 106 that may be configured to move (e.g., pivot) the closure 104 between a closed position and an open position (as indicated by the directional arrow). The closure assembly 110 may also include one or more latch assemblies or latches 108 (e.g., two latches 108 one disposed on each side of the closure 104. Each of the latches 108 may be configured to engage a striker 112 that may be fixed to the vehicle body 102. In other embodiments, the striker 112 may be fixed to the closure 104 and the latch 108 may be fixed to the body 102.

In one or more embodiments, the closure assembly 110 may include one or more controllers 114 configured to communicate with the latches 108, the power drive unit 106, or both. The controller 114 may be part of a larger control system and may be controlled by various other controllers throughout the vehicle 100, such as a body control module (BCM) or vehicle system controller (VSC). Therefore, the controller 114 and one or more other controllers can be collectively referred to as a “controller” that controls various actuators in response to signals from various sensors to control functions such as changing states of the latch 108 between an open state, a mechanical secondary state, in which the closure 104 is partially closed, and a mechanical primary state, in which the closure 104 is completely closed. The controller 114 may also control the power drive unit 106 to move the closure 104 between the closed position or partially closed position to the open position.

The controller 114 may include a microprocessor or central processing unit (CPU) in communication with various types of computer readable storage devices or media. Computer readable storage devices or media may include volatile and nonvolatile storage in read-only memory (ROM), random-access memory (RAM), and keep-alive memory (KAM), for example. KAM is a persistent or non-volatile memory that may be used to store various operating variables while the CPU is powered down. Computer-readable storage devices or media may be implemented using any of a number of known memory devices such as PROMs (programmable read-only memory), EPROMS (electrically PROM), EEPROMs (electrically erasable PROM), flash memory, or any other electric, magnetic, optical, or combination memory devices capable of storing data, some of which represent executable instructions, used by the controller 114 in controlling the closure assembly 110 or the vehicle 100.

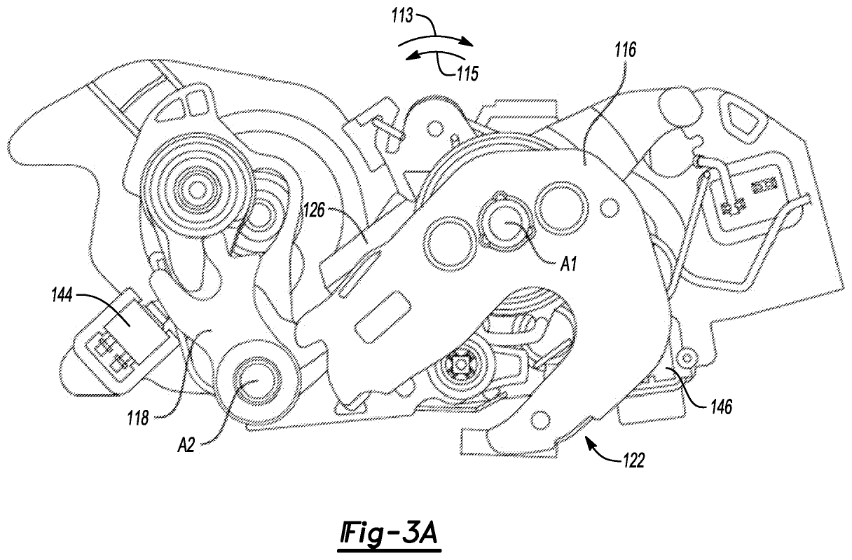

FIG. 2 illustrates a perspective view of the latch assembly 108 according to one or more embodiments. The latch assembly 108 may include a latch mechanism 122 that be disposed in a housing 120. The latch mechanism 122 may include the catch 116, the pawl, and other components (not illustrated) configured to cooperate with the pawl and the catch 116.

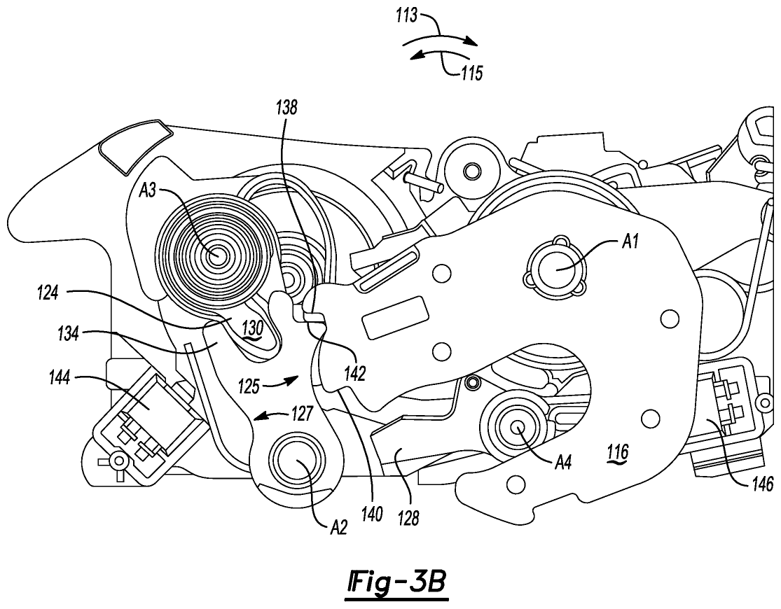

FIGS. 3A-3C illustrate one example arrangement of the latch mechanism 122. FIG. 3A illustrates a plan view of the latch mechanism 122 in the open state, FIG. 3B illustrates a plan view of the latch mechanism 122 in the secondary state, and FIG. 3C illustrates a plan view of the latch mechanism 122 in the primary state. The catch 116 may be configured to pivot or rotate about a first axis A1 to switch between different positions. The catch 116 includes an open position (FIG. 3A) in which the latch 108 is in an open state and disengaged from the striker 112, a first closed position (FIG. 3B) in which the latch 108 is in a partially closed state and is engaged with the striker to retain the closure 104 in a partially closed position, and a second closed position (FIG. 3C) in which the closure 104 is fully closed. As the state of the latch 108 changes from the first closed position to the second closed position, the catch 116 may pull against the striker 112 to cinch or pull the closure 104 to the second closed position (e.g., the fully closed position).

The catch 116 switches between the open position and the closed position by rotating about the first axis A1. The catch 116 moves from the open position to the closed position by rotating in the closing direction 113 (which is clockwise in the illustrated orientation) and moves from the closed position to the open position by rotating in the opening direction 115 (which is counterclockwise in the illustrated orientation). The catch 116 includes an associated clutch lever 136 arranged to pivot about the first axis A1 to rotate the catch 116 between the open position and the closed position. Alternatively, the catch lever 126 may pivot about an axis that is offset from the first axis A1. The catch 116 may be biased towards the open position by one or more resilient members either acting directly or indirectly on the catch. In one embodiment, a pair of springs biases the catch 116 in the opening direction 115.

The latch 108 may include a pawl 118 configured to rotate about a second axis A2. The pawl 118 is configured to engage with the catch 116 to retain the catch 116 in one or more closed positions. For example, the pawl 118 includes a first blocking surface 142 configured to engage with a first detent 138 of the catch 116 to retain the catch 116 in a partially closed position (FIG. 3B). A second detent 140 of the catch 116 to retain the catch in the fully closed position. The pawl 118 is rotatable about the second axis A2 in a blocking direction 125 that brings the pawl 118 into contact with the catch 116 and a free direction 127 that rotates the pawl 118 away from contact with the catch 116. The pawl 118 may be biased in the blocking direction 125 by one or more resilient members acting either directly or indirectly on the pawl 118.

A pawl lever 124 is configured to rotate the pawl 118. The pawl lever 124 may be rotatable about a third axis A3 that is offset relative to the second axis A2. The pawl lever 124 may include an arm 130 that extends from the axis A3 to interact with the pawl 118. For example, the pawl 118 defines a fork 133 that receives the arm 130 therein so that rotation of the pawl lever 124 is input to the pawl 118. Rather than attaching a resilient member to the pawl 118, the pawl lever 124 may be biased to urge the pawl 118 towards the blocking direction.

The geometry of the pawl 118 and the catch 116 may be designed to allow the catch 116 to slide over the pawl 118 in the closing direction 113. However, to reduce the closing effort, the pawl 118 may be rotated and held out of the path of the catch 116 during closing by a blocking lever 128 (sometimes referred to as a coupling lever). The blocking lever 128 holds the pawl 118 away from the catch 116 during closing. The blocking lever 128 may be configured to rotate about a fourth axis A4 and contact and block the pawl lever 124 as the catch 116 rotates from the open position towards the closed position. As stated above, pawl lever 124 and pawl 118 may be biased towards the blocking direction and the blocking lever 128 may be configured to block the pawl 118, by contacting the pawl lever 124, to create a gap between the pawl 118 and the catch 116, so the catch is more easily movable to in the closing direction 113. As an example, the blocking lever 128 forms the gap so that the catch 116 may move towards the closed position without engaging or moving the pawl 118. Avoiding contact with the pawl 118 may result in lower forces required to change the state of the latch 108 to a partially closed or secondary state and a fully closed or primary state. In one or more embodiments, the blocking lever 128 may be arranged with the catch lever 126 so that as the catch lever 126 rotates, the blocking lever 128 also rotates in coordination.

As will be described in greater detail below, the latch 108 may include a one or more sensors (e.g., a first switch 144 and a second switch 146) that may be configured to detect a number of positions of one or more components (e.g., the pawl 118 and the catch 116) of the latch 108. As an example, as the latch 108 operates (e.g., changes between the open state, to the secondary position, to the primary position and vice-versa) the first switch 144 may be configured to detect one or more positions of the pawl 118 and the second switch 146 may be configured to detect one or more positions of the catch 116. The switches 144, 146 may be microswitches.

A more in-depth discussion of the latch assembly can be found in Applicant's co-pending application U.S. 60/219,069, filed Jul. 7, 2021, which is hereby incorporated in its entirety by reference herein.

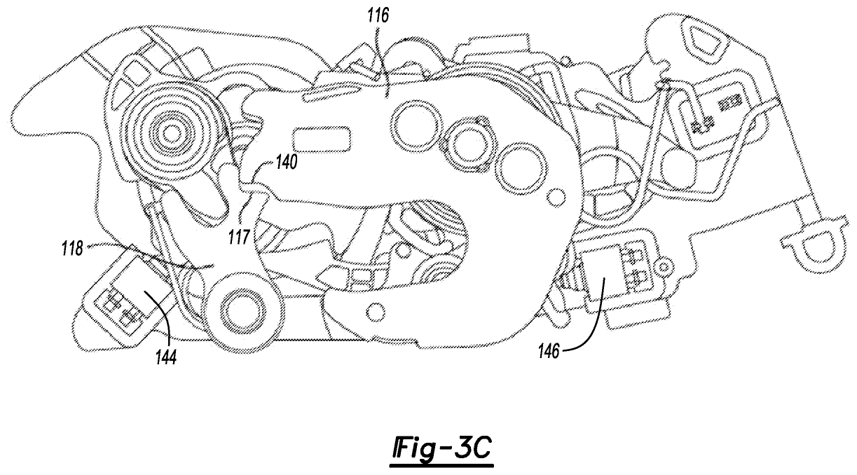

FIG. 4 illustrates a schematic wiring diagram of an exemplary electrical circuit 162 that is configured to operate the latch 108. The electrical circuit 162 may include the first and second switches 144, 146 that may be electrically connected to the controller 114. The first switch 144 may be electrically connected to a first pin 160 by a first wire or electrical trace 148. The second switch 146 may be electrically connected to a second pin 158 by a second wire or second electrical trace 152. The first and second switches 144, 146 may each be connected to one another and to a third pin 158 by a common trace 150.

The common trace 150 may provide power or electrical current to the first and second switches 144, 146 and under certain conditions (e.g., the catch 116 or the pawl 118 moving to one or more predetermined positions) switching legs 154 of the first and second switches 144, 146 may be actuated to close the either the circuit formed by the first switch 144, the first trace 148, and the common 150, or to close the circuit formed by the second switch 146, the second trace 152, and the common 150, or both of the circuits. The controller 114 may provide or communicate power to the first, second, and third pins 156, 158, 160, though in other embodiments, power may be provided via another wire or another controller 114. In response to the first switch 144, the second switch 146, or both being in the closed state first signals and second signals may be communicated to the controller 114.

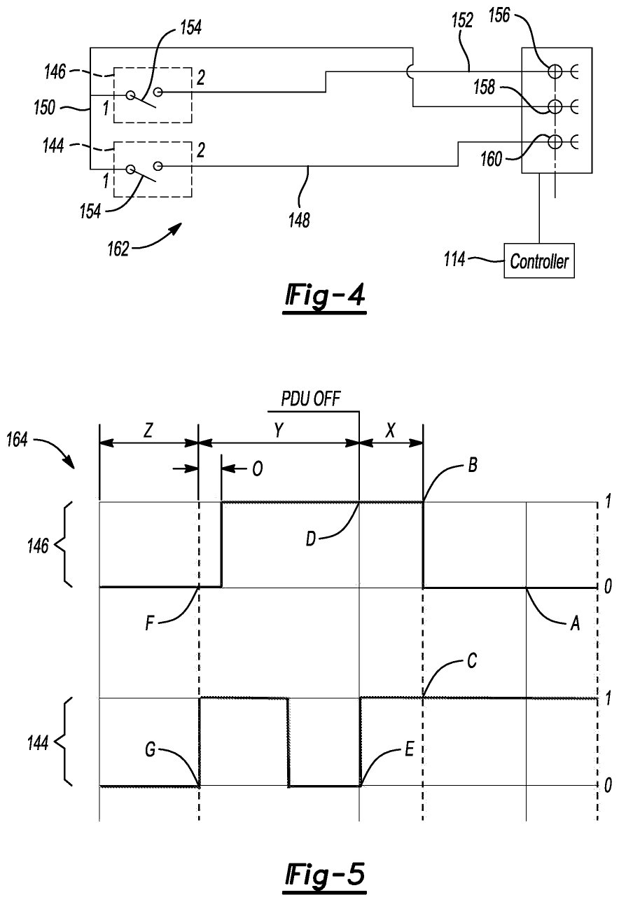

FIG. 5 illustrates a graphical representation of actuation of a closure assembly. The graph 164 includes two graphed lines representing the states (e.g., open and closed) of the first and second switches 144, 146. As an example, the 0 and 1 depicted on the right side of the graph 164 represent the first and second switches 144, 146 being open and closed, respectively. From the right side of the graph 164, points A, B, and C represent the pawl 116 and the catch 118 being in the open position and moving towards a pre-secondary position. At points B and C, the pawl 116 and the catch 118 reach the pre-secondary position and points D and E represent the pawl 116 and the catch 118 reaching the secondary position, in which the closure 104 is partially closed.

Upon reaching the secondary position, as represented by points D and E, the power drive unit 106 may be commanded to turn off, as represented by “PDU Off.” At points F and G, the pawl 116 and the catch 118 may move so that the first and second switches are in the open state and the pawl 116 and the catch 118 are in the primary closed position (e.g., indicative of the closure 104 being in the fully closed position). In one or more embodiments, the first switch 144 may change between the open state to the closed state and back to the open state and the second switch 146 may remain in the closed state prior to reaching point F.

The variables X, Y, Z, and O may represent time or travel with respect to time between various points actuation of the latch. As an example, the variables representing travel with respect to time may refer to a distance traveled by closure element with respect to the striker 112. The chart below includes ranges for each of the variables.

TABLE 1

| | Minimum | Maximum |
|---|---|---|
| Variable | (mm/min) | (mm/min) |
| X | 1.2 | 3.7 |
| Y | 3 | 9 |
| Z | 1 | 3 |
| O | 0.75 | 2.25 |

The algorithms, methods, or processes disclosed herein can be deliverable to or implemented by a computer, controller, or processing device, which can include any dedicated electronic control unit or programmable electronic control unit. Similarly, the algorithms, methods, or processes can be stored as data and instructions executable by a computer or controller in many forms including, but not limited to, information permanently stored on non-writable storage media such as read only memory devices and information alterably stored on writeable storage media such as compact discs, random access memory devices, or other magnetic and optical media. The algorithms, methods, or processes can also be implemented in software executable objects. Alternatively, the algorithms, methods, or processes can be embodied in whole or in part using suitable hardware components, such as application specific integrated circuits, field-programmable gate arrays, state machines, or other hardware components or devices, or a combination of firmware, hardware, and software components.

While exemplary embodiments are described above, it is not intended that these embodiments describe all possible forms encompassed by the claims. The words used in the specification are words of description rather than limitation, and it is understood that various changes can be made without departing from the spirit and scope of the disclosure. As previously described, the features of various embodiments can be combined to form further embodiments of the invention that may not be explicitly described or illustrated. While various embodiments could have been described as providing advantages or being preferred over other embodiments or prior art implementations with respect to one or more desired characteristics, those of ordinary skill in the art recognize that one or more features or characteristics can be compromised to achieve desired overall system attributes, which depend on the specific application and implementation. These attributes can include, but are not limited to cost, strength, durability, life cycle cost, marketability, appearance, packaging, size, serviceability, weight, manufacturability, ease of assembly, etc. As such, to the extent any embodiments are described as less desirable than other embodiments or prior art implementations with respect to one or more characteristics, these embodiments are not outside the scope of the disclosure and can be desirable for particular applications.

### Parts List

The following is a list of reference numbers shown in the Figures. However, it should be understood that the use of these terms is for illustrative purposes only with respect to one embodiment. And, use of reference numbers correlating a certain term that is both illustrated in the Figures and present in the claims is not intended to limit the claims to only cover the illustrated embodiment.
100 vehicle
102 vehicle body
104 closure
106 power drive unit
108 latch assemblies
110 closure assembly
112 striker
113 closing direction
114 controller
116 catch
117 opening direction
118 pawl
120 housing
122 latch mechanism
124 pawl lever
125 blocking direction
126 catch lever
127 free direction)
128 blocking lever
130 lever
132 arm
134 fork
136 clutch lever
138 first detent
140 second detent
142 first blocking surface
144 pawl switch
146 catch switch
148 first trace
150 common trace
152 second trace
154 switching legs
156 third pin
158 second pin
160 first pin
162 circuitry
164 graph

What is claimed is:

1. A latch assembly for use in a vehicle, the latch assembly configured to be fixed to a vehicle body of the vehicle or a closure of the vehicle, the latch assembly comprising:
a catch;
a pawl;
a controller; and
circuitry electrically connected to the controller and including,
a first switch operable between a closed state, in which the first switch is configured to send first signals to the controller, and an open state,
a second switch operable between a closed state, in which the second switch is configured to send second signals to the controller, and an open state,
wherein the controller configured to,
responsive to receiving the first signals and not receiving the second signals, collectively indicative of the pawl and the catch each moving from an open position towards a secondary position indicative of a first closed position,
initiate a cinching sequence, in which the catch is configured to move from the secondary position to a primary position indicative of a second closed position.

2. The latch assembly of claim 1, wherein the first and second switches are electrically connected to one another by a common electrical connection.

3. The latch assembly of claim 2, wherein the first and second switches are electrically connected to one another by only one common electrical connection.

4. The latch assembly of claim 1, wherein the pawl and the first switch are arranged such that when the pawl is in the open position, the pawl is spaced apart from the first switch so that the first switch is in the open state.

5. The latch assembly of claim 1, wherein the vehicle body includes a striker and the latch assembly is fixed to the closure, and in the first closed position, the catch engages the striker to hold the closure in the first closed position, in which the closure is partially closed.

6. The latch assembly of claim 1, wherein the closure is a tailgate and the vehicle body includes a truck bed configured to be closed by the tailgate.

7. A closure assembly for use in a motor vehicle provided with a body and a closure element configured to move with respect to the body between an open position, a first closed position, and a second closed position, the closure assembly comprising:
a latch assembly configured to be fixed to the body or the closure element, the latch assembly including:
a catch,
a pawl, wherein the catch and the pawl are collectively configured to move between an open position, a secondary position, and a primary position, wherein the pawl and the catch are collectively configured to cooperate with one another in at least one of the secondary position and the primary position,
a first switch operable between a closed state and an open state and configured to detect positions of at least one of the catch and the pawl;
a second switch operable between a closed state and an open state, and configured to detect positions of the other of the at least one of the catch and the pawl; and
a controller configured to, responsive to one of the first and second switches being in the closed state, collectively indicative of the pawl and the catch each moving from the open position towards the secondary position, initiate a cinching sequence, in which the catch is configured to move from the secondary position to a primary position indicative of the second closed position.

8. The closure assembly of claim 7, wherein the second switch is configured to detect a number of positions of the pawl including the open position, the first closed position, and the second closed position, wherein the secondary position of the pawl is indicative of the first closed position of the closure element, in which the closure element is at least partially closed.

9. The closure assembly of claim 8, further comprising:
a power drive unit operatively connected to the closure element, the power drive unit including a motor configured to rotate in a first rotational direction to move the closure element from the open position towards the second closed position, wherein the controller is further configured to, responsive to the second switch changing from the closed state to the open state, indicative of the pawl reaching a secondary position, command the power drive unit to stop the motor.

10. The closure assembly of claim 9, further comprising:
a latch motor operatively coupled to at least one of the catch and the pawl, wherein the controller is further configured to, responsive to receiving a closing command, command the power drive unit to actuate the motor and actuate the latch motor to move the catch to change the first switch from the open state to the closed state prior to the catch reaching the secondary position.

11. The closure assembly of claim 10, wherein as the catch moves from the open position to the secondary position, the first switch is in the open state for a first predetermined period.

12. The closure assembly of claim 11, wherein the controller is further configured to command the latch motor to stop rotating in response to the first switch and the second switch being in the open state for a second predetermined period, wherein the second predetermined period is less than the first predetermined period.

13. The closure assembly of claim 8, further comprising:
a power drive unit operatively connected to the closure element, the power drive unit including a motor configured to rotate in a first rotational direction to move the closure element from the open position so that the closure element is in the first closed position, wherein the controller is further configured to, responsive to the first switch being in the closed state, command the power drive unit to stop the motor.

14. The closure assembly of claim 8, wherein the catch reaches the primary position prior to the pawl reaching the secondary position.

15. A method of operating a closure assembly including a latch and a closure, the method comprising:
receiving, by a controller, first signals from a first switch, the first switch operable between an open state and a closed state, in which the first switch sends the first signals to the controller,
not receiving, by the controller, second signals from a second switch operable between an open state and a closed state, in which the second switch sends the first signals to the controller; and
performing, by the controller, a cinching operation,
wherein the receiving step and the not receiving step are collectively indicative of a pawl and a catch of the latch each moving from an open position to a secondary position indicative of the closure being in a first closed position.

16. The method of claim 15, further comprising:
commanding, by the controller, a power drive unit to actuate so that the closure moves from an open position to the first closed position; and
commanding, by the controller, a latch motor to move the pawl and the catch from the open position to the secondary position.

17. The method of claim 16, further comprising:
stopping, by the controller, the power drive unit, wherein the commanding the latch motor step includes the second switch changing from the closed state to the open state, and the stopping step is performed in response to the second switch changing from the closed state to the open state.

18. The method of claim 17, wherein the performing step includes moving the pawl and the catch so that second switch changes from the open state, to the closed state, and to the open state indicative of at least one of the pawl and the catch being in a primary closed position in which the closure is in a second closed position.

19. The method of claim 18, wherein the performing step further includes moving the pawl and the catch so that first switch changes from the closed state to the open state.

20. The method of claim 19, wherein the first switch changes from the closed state to the open state prior to the second switch changing from the closed state to the open state.
